(19) United States
(12) Patent Application Publication
(10) Pub. No.: US 2011/0232021 A1
(43) Pub. Date: Sep. 29, 2011

(54) WINDSHIELD WIPER DRIVE

(75) Inventor: Lothar Trenkle, Ottersweier (DE)

(73) Assignee: ROBERT BOSCH GMBH, Stuttgart (DE)

(21) Appl. No.: 13/058,969

(22) PCT Filed: May 6, 2009
(86) PCT No.: PCT/EP2009/055492

§ 371 Date: May 10, 2011

(30) Foreign Application Priority Data
Aug. 13, 2008 (DE) 10 2008 041 226.0

(51) Int. Cl. B60S 1/24

(52) U.S. Cl. 15/250.31

(57) ABSTRACT

A windscreen wiper drive (300) for a vehicle, in particular a motor vehicle, comprises a crank device (320) which can be driven by a drive shaft (310) of an electric motor. A recess in the crank device (320) assumes an end section of the drive shaft (310), wherein an axial position of the crank device (320) on the drive shaft (310) is defined by a shoulder which bounds the recess.

### BACKGROUND OF THE INVENTION

The invention relates to a windshield wiper drive. In particular, the invention relates to a windshield wiper drive for use in a motor vehicle.

Windshield wiper systems in motor vehicles customarily comprise an electric driving motor which sets one or more wiper arms into an oscillating movement by means of a crank mechanism. A wiper is fastened to each wiper arm in such a manner that, when the driving motor rotates, said wiper brushes in an oscillating manner over a motor vehicle window in order to clean the latter.

Various variant embodiments of crank mechanisms are known in the prior art in order to convert the rotational movement of the electric motor into the oscillating movement of the wiper arms. A crank device is customarily mounted on an output shaft of the electric motor, and a connecting rod which is connected to the crank device by means of a bearing fastened eccentrically on the crank device converts the circular movement of the electric motor into the oscillating movement.

One option for connecting the crank device to the output shaft of the electric motor is a knurled tapered shaft end connection according to DIN 72783. In this connection, one shaft end has a section having an external thread and an adjoining, knurled tapered section. The shaft end is inserted through a tapered bore, which corresponds to the tapered section, in the crank device and is tightened on the external thread by means of a hexagon nut. In a fitted position, the shaft end with the hexagon nut projects in the axial direction beyond the crank device. During operation, the electric motor rotates the crank device in a rotational plane perpendicular to the output shaft. One or more connecting rods are connected to the crank device by means of a connecting rod joint (or connecting rod bearing) mounted on the crank device outside the axis of rotation of the output shaft. The connecting rods extend substantially in a plane parallel to the rotational plane of the crank device. So that during rotation of the crank device, the connecting rod can run over the shaft end and the hexagon nut, the connecting rod joint therefore has to be offset outward on the crank device axially with respect to the output shaft. This can be brought about for example, by the crank device being bent in the axial direction. Various embodiments of a crank device and the fastening thereof on the output shaft are shown in DE 102 59 956 A1. A further variant embodiment can be gathered from DE 198 04 954 A1.

### SUMMARY OF THE INVENTION

The invention is based on the object of specifying a windshield wiper drive which has a flat construction in the axial direction.

The windshield wiper drive according to the invention has the advantage in particular of having a flat construction in an axial direction of an output shaft of the electric motor and of being able to be produced and fitted easily and cost-effectively.

In one embodiment, a connecting rod joint which couples a connecting rod which, for its part, is connected to a wiper arm is fastened to the crank device. In this case, during operation of the electric motor, the connecting rod extends substantially in a plane which is perpendicular to the output shaft. The crank device fastening, according to the invention and being of flat construction, on the output shaft may make it unnecessary to offset the connecting rod joint outward in an axial direction of the output shaft in order to prevent the connecting rod, during operation, from colliding with the end of the output shaft or with a fastening means connected thereto. This enables installation space and production costs to be saved; in many cases, there may also be a positive effect on the capability of fitting and ease of servicing the arrangement.

The invention can be used, for example, for a crank or for a crank mechanism in a windshield wiper system. The windshield wiper system can be provided, for example, for cleaning a windshield, a rear window or a headlamp of the motor vehicle.

In a preferred embodiment, an output shaft of the electric motor has a blunt (i.e. substantially flat) shaft end which interacts with a planar floor of the blind hole in order to define the axial position of the crank device on the output shaft. The floor of the blind hole is located here in a plane perpendicular to the output shaft. The recess in the crank device may have a passage hole in the region of the shoulder.

A fastening screw having an external thread may extend through the passage hole in the crank device into a coaxial hole, which is provided with an internal thread, in the output shaft.

In a further embodiment, the crank device may have one or more passage holes which do not run coaxially with respect to the output shaft and which correspond to holes in the output shaft. As described above, fastening screws may be provided in order to fasten the crank device to the output shaft. As an alternative thereto, other known fastening means may also be used, for example rivets or fixing pins.

The screw is preferably a countersunk screw, for example with an actuating means on the end side, for example a hexagon socket, an internal torx or end holes, or a radial actuating means, for example a polygonal head, for instance an external torx or a hexagon head.

The screw may also be used to pull or press the crank device onto the output shaft during installation. During installation of this type, it is possible that a chip may become peeled from a wall of the blind hole or from the output shaft, said chip possibly being placed onto the floor of the blind hole between the crank device and the output shaft in such a manner that both the axial position of the crank device on the output shaft and the alignment of the crank device perpendicularly to the output shaft are affected.

Therefore, in one refinement, in a shoulder region bounded by the wall and the floor of the blind hole, the crank device has an encircling chip space for receiving a chip of this type. The chip space may be formed, for example, by a bead or depression in the radial and/or axial direction in the crank device. Furthermore, the chip space may be enlarged or formed by a bevel at the end of the output shaft. If the bevel on the output shaft is of a sufficient size, the chip space on the shoulder may be omitted.

A torque to be transmitted between the output shaft and the crank device may be partially transmitted to the wall of the blind hole via a radial contact surface of the shaft. In addition or as an alternative thereto, some of the torque may be transmitted between an end side of the shaft end of the output shaft and the floor of the blind hole.

In order to improve a coefficient of friction between the output shaft and the crank device, one or both elements may be textured in the region of mutual engagement. A texturing may be designed in the form of a knurl, for example a cylinder knurl or a knurl running obliquely. In the customary, known variations, the knurl may be designed, for example, as a left-handed knurl, right-handed knurl, left- and right-handed knurl or as an axial and circumferential knurl, in each case with raised or recessed points. According to the invention, texturing may also take place by means of a splined or toothed profile; in this case too, the texturing may be provided alternatively on the output shaft, on the crank device or on both elements.

In the region of engagement between the crank device and output shaft, the largest external diameter of the output shaft may be larger than the smallest internal diameter of the crank device. An arrangement of this type is customary, for example, when a fit or shrink connection is used, but also when texturing is used on the output shaft and/or the crank device. In the latter case, the diameters can be coordinated with each other in such a manner that, during the pulling or pressing on operations, the texturings, for example knurled turns, of one element dig into a material of the other element and thus produce a torque-locking connection. When digging in of this type takes place, it is likely that a chip will be peeled off in the engagement region of the two elements. Further factors may assist the formation of chips, for example pairing of materials or repeated fitting and removal of the crank device onto/from the output shaft. For this reason, provision of a chip space, in particular in conjunction with texturing of the output shaft and/or of the crank device, is particularly advantageous.

In a further embodiment, an external diameter of the output shaft in a textured region corresponds to an external diameter of the output shaft in an adjacent, non-textured region. This may be ensured, for example, by the shaft and textured region brushing over each other.

According to a further aspect of the invention, a windshield wiper device for a vehicle, in particular for a motor vehicle, comprises the windshield wiper device described above.

### BRIEF DESCRIPTION OF THE DRAWINGS

Exemplary embodiments of the invention are illustrated in the drawings and are explained in more detail in the description below, in which:

FIG. 1 shows a knurled tapered shaft end connection, which is known in the prior art, of an output shaft with a crank device of a windshield wiper drive;

FIG. 2 shows a longitudinal section through the knurled tapered shaft end connection from FIG. 1;

FIG. 3 shows a windshield wiper drive according to the invention in a perspective view; and

FIG. 4 shows the windshield wiper drive from FIG. 3 in a longitudinal section.

Identical or mutually corresponding elements bear the same reference numbers in all of the figures.

### DETAILED DESCRIPTION

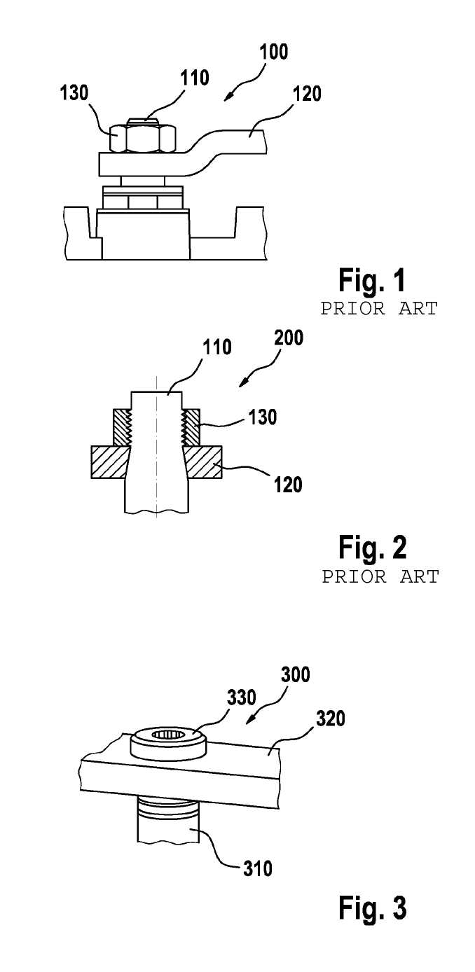

FIG. 1 shows a windshield wiper drive 100 from the prior art, said windshield wiper drive comprising an output shaft 110, a crank device 120 and a securing nut 130. The motor housing section illustrated in the lower region of FIG. 1 is not of importance in this connection.

The bent design of the crank device 120 can be seen clearly. The bend ensures that a connecting rod joint (not shown) which is mounted on an upper side of the crank device 120 is located high enough in the axial direction that a connecting rod (not shown) which is fastened to the connecting rod joint collides neither with the securing nut 130 nor with the shaft 110 when the output shaft 110 rotates.

FIG. 2 shows a longitudinal section 200 of an upper section of the windshield wiper drive from FIG. 1. Only an unbent section of the crank device 120 is illustrated here. It can be seen how the securing nut 130 can be used to press the crank device 120 downward in FIG. 2 onto the shaft 110 in order to connect a conical section of the shaft 110 to a corresponding conical holder of the crank device 120 in a torque-locking manner. A knurled tapered shaft end connection along the tapered surfaces of the shaft 110 and the crank device 120 is not illustrated in FIG. 2.

FIG. 3 shows a windshield wiper drive 300 according to the invention in a laterally raised view. A crank device 320 is mounted on an output shaft 310 of an electric motor by means of a countersunk screw 330. In a comparison of the arrangement with those in FIGS. 1 and 2, it can be seen that the countersunk screw 330 requires significantly less construction space in the axial direction than the corresponding securing nut 130 of the windshield wiper drive from the prior art according to FIGS. 1 and 2. Accordingly, the crank device 320 is of flat design, i.e. extends substantially in a rotational plane running perpendicularly to the output shaft, instead of having a bend. With the illustrated windshield wiper drive 300 which has a flat construction, a connecting rod (not illustrated) can be coupled by means of a connecting rod joint (not illustrated) to the unbent crank device 120 without the connecting rod colliding with the countersunk screw 330 when the output shaft 310 rotates.

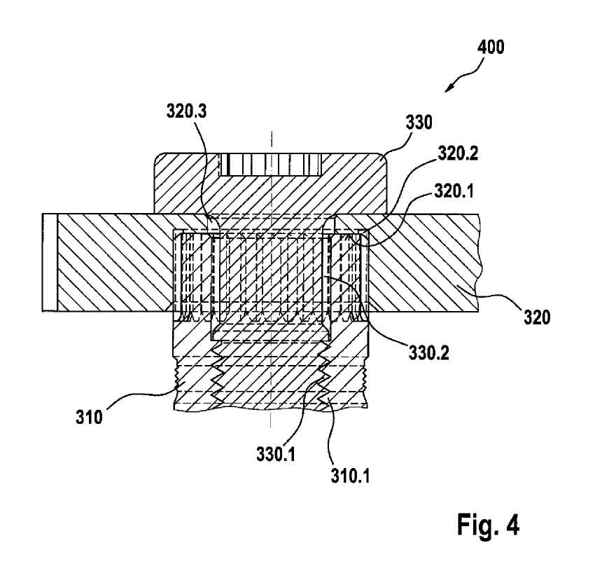

FIG. 4 shows a longitudinal section 400 through the windshield wiper drive 300 according to the invention from FIG. 3. It is clear how the crank device 320 is mounted on the output shaft 310 by means of the countersunk screw 330. The output shaft 310 has a coaxial internal thread 310.1 in which an external thread 330.1 of the countersunk screw 330 engages. In addition, the output shaft 310 bears a cylinder knurl 310.2. The cylinder knurl 310.2 is in frictional connection with the crank device 320 in the radial direction of the output shaft 310. In the embodiment illustrated, the crank device 320 has a non-textured surface in the region of the cylinder knurl 310.2, i.e. is not knurled. In alternative embodiments, the crank device 320 may bear a corresponding knurling along the radial contact surface with the output shaft 310 in order to improve transmission of torque. In a further embodiment, it is also possible, instead of a knurling, to provide a toothing or profiling on one or both elements, for example a multiple splined profile, a torx connection, a toothing or any polygonal profile.

An end surface of the output shaft 310 interacts with a bottom surface 320.1 of the crank device 320 in order to define an axial position of the crank device 320 on the output shaft 310. At the same time, said contact surface can transmit some of a torque between the crank device 320 and the output shaft 310.

An encircling depression 320.2 in the crank device 320 serves as a chip space. If, as the crank device 320 is pulled or pressed onto the output shaft 310, a chip becomes detached from the crank device 320 or the output shaft 310, for example from the cylinder knurl 310.2, the chip space 320.2 can serve to receive said chip in order to keep said chip away from being placed onto the end side bottom surface 320.1 of the output shaft 310. In this manner, a force-fitting and torque-locking connection between the crank device 320 and the output shaft 310 can be ensured by the cylinder knurl 310.1 while at the same time it is ensured that the crank device 320 sits correctly on the output shaft 310.

Between a head and an external thread 330.1, the countersunk screw 330 has a neck section 330.2 which has smaller diameter than the external thread 330.1. If the countersunk screw 330 is tightened, the neck section 330.2 expands and acts as an axial spring. This causes a pre-stress between the head of the countersunk screw and the thread 330.1 which opposes loosening of the countersunk screw 330, for example due to operationally induced stresses or externally introduced vibration. The shoulder indicated in FIG. 4 between the thread 330.2 and the neck section 330.1 is necessitated by the illustration and does not support the countersunk screw 330 against an upper edge of the internal thread 310 of the output shaft.

A passage hole 320.3 of the crank device 320 is dimensioned in such a manner that the countersunk screw 330 has radial play in the region of the passage hole 320.3.

By means of the windshield wiper drive according to the invention it is possible to produce a force-fitting and torque-locking connection between the crank device 320 and the output shaft 310, which connection is flat enough to enable an axial offset of a connecting rod joint fitted on the crank device 320 to be omitted under certain circumstances. The force or torque connection between the crank device 320 and the output shaft 310 may be ensured by a knurl, which is easy to produce, on one or both elements, with a chip space (depression 320.2) ensuring that the crank device 320 is correctly aligned with the output shaft 310.

1. A windshield wiper drive (300) for a vehicle, with a crank device (320) configured to be driven by an output shaft (310) of an electric motor, wherein a recess in the crank device (320) receives an end section of the output shaft (310), and an axial position of the crank device (320) on the output shaft (310) is defined by a shoulder bounding the recess.

2. The windshield wiper drive as claimed in claim 1, wherein the recess comprises a blind hole, and the floor of the blind hole is substantially planar in order to interact with a blunt end of the output shaft (310).

3. The windshield wiper drive as claimed in claim 1, wherein, in the region of the shoulder, the crank device (320) has a passage hole (320.3) for receiving a fastening means (330) fastening the crank device (320) to the output shaft (310).

4. The windshield wiper drive as claimed in claim 3, wherein the output shaft (310) has a coaxial hole which is provided with a thread (310.1) and which corresponds to the passage hole (320.3) in the crank device (320).

5. The windshield wiper drive as claimed in claim 1, wherein, in the region of the shoulder, the crank device (320) has a chip space (320.2) running along a wall of the recess.

6. The windshield wiper drive as claimed in claim 5, wherein the chip space (320.2) is formed by a bead or depression in the crank device (320).

7. The windshield wiper drive as claimed in claim 1, wherein, in a mutual engagement region in the radial direction, the blind hole and/or the output shaft (310) have texturing in order to transmit a torque.

8. The windshield wiper drive as claimed in claim 7, wherein the texturing comprises a cylinder knurl.

9. The windshield wiper drive as claimed in claim 7, wherein an external diameter of the output shaft (310) in a textured region corresponds to an external diameter of the output shaft (310) in an adjacent, non-textured region.

10. A windshield wiper device for a vehicle, with a windshield wiper drive as claimed in claim 1.

11. The windshield wiper drive as claimed in claim 2, wherein, in the region of the shoulder, the crank device (320) has a passage hole (320.3) for receiving a fastening means (330) fastening the crank device (320) to the output shaft (310).

12. The windshield wiper drive as claimed in claim 11, wherein the output shaft (310) has a coaxial hole which is provided with a thread (310.1) and which corresponds to the passage hole (320.3) in the crank device (320).

13. The windshield wiper drive as claimed in claim 12, wherein, in the region of the shoulder, the crank device (320) has a chip space (320.2) running along a wall of the recess.

14. The windshield wiper drive as claimed in claim 13, wherein the chip space (320.2) is formed by a bead or depression in the crank device (320).

15. The windshield wiper drive as claimed in claim 14, wherein, in a mutual engagement region in the radial direction, the blind hole and/or the output shaft (310) have texturing in order to transmit a torque.

16. The windshield wiper drive as claimed in claim 15, wherein the texturing comprises a cylinder knurl.

17. The windshield wiper drive as claimed in claim 16, wherein an external diameter of the output shaft (310) in a textured region corresponds to an external diameter of the output shaft (310) in an adjacent, non-textured region.
